(19) United States
(12) Patent Application Publication
(10) Pub. No.: US 2026/0212010 A1
(43) Pub. Date: Jul. 23, 2026

(54) Method for managing a set of IP addresses, collaboration method, and devices configured to implement these methods

(71) Applicant: ORANGE, Issy-les-Moulineaux (FR)

(72) Inventors: Mohamed BOUCADAIR, CHATILLON (FR); Christian JACQUENET, CHATILLON CEDEX (FR)

(21) Appl. No.: 19/136,652

(22) PCT Filed: Dec. 7, 2023
(86) PCT No.: PCT/EP2023/084648

§ 371 Date: Jun. 6, 2025

(30) Foreign Application Priority Data
Dec. 8, 2022 (FR) 2213026

(51) Int. Cl. G06F 21/55

(52) U.S. Cl. CPC G06F 21/554; G06F 2221/034

(57) ABSTRACT

A management method includes detecting suspicious behavior associated with an IP address of a first set of IP addresses selected by a first device of a network to process at least one packet of a client equipment served by the first device. At least one action is carried out among: adjustment of at least one level of sharing of at least one IP address of the first set, applied by the first device; and asking at least one second device managing a second set of IP addresses to delegate at least one IP address of the second set to the first device so that it is able to select this delegated IP address to process at least one packet of at least one client equipment served by the first device.

### PRIOR ART

The invention belongs to the general field of telecommunications.

It relates to the management of a connectivity service, more particularly in the case of cyber attacks in a telecommunications network, such as for example Distributed Denial of Service (or DDOS) attacks.

In a manner known per se, a DDOS attack is an attempt to render resources (for example processing resources or network resources) unavailable to their users. Such attacks may be massive and be aimed at compromising several hundreds of thousands of client equipments (for example terminals), which may in turn be used as relays for amplifying the detrimental effect of the attacks. These attacks are increasing in frequency and intensity; their size in terms of duration but also of extent and of propagation makes difficult the task of the DPS (for “DDOS Protection Service”) service or services deployed within the network for detecting and mitigating such attacks (for example via a quarantining of the resources targeted by the attacks, filtering of the traffic associated with an attack, etc.).

Furthermore, the instigation of mitigation actions within a network is particularly problematic in the presence of address translation devices also referred to as operator NATs (for “Network Address Translator”) (or else CGN for “Carrier Grade NAT”, or LSN for “Large Scale NAT”).

An operator NAT is a device implementing a function for translating IP addresses (and, where relevant, port numbers) in an operator network. Several types of operator NAT have been specified by the IETF (for “Internet Engineering Task Force”) and deployed by the operators (for example NAT44, NAT64, DS-Lite, NPTv6, etc.). For example, in a “double NAT” architecture, the NAT function of a CGN will be added to the onboard NAT function in the client equipment for accessing the network (for example in a CPE for “Customer Premises Equipment”). The network architectures based on the exploitation of CGNs notably allow a mechanism for sharing IP addresses to be established, offering for example a solution for continuity of service in a context of lack of IPV4 addresses.

For example, an “internal” address (for example a private address in the case of a double NAT design) is assigned instead and in place of another address, referred to as “external” (for example a global IPV4 address in the case of a double NAT design, notably) to the connection interface of the equipment (for example a CPE) for the client to access the network. The translation of the internal address assigned to the connection interface of the access equipment into an external address is carried out by the operator NAT (CGN). FIG. 1 illustrates, in one example, the various translations of addresses carried out respectively by an access equipment CPE1 and by an operator NAT CGN2 on IP data packets generated by a terminal H3, connected for example to a corporate network or a home network, and destined for a remote equipment S4.

Thus, in the example in FIG. 1, a packet P of IP data having as source IP address 10.2.25.5 and source port number 12345 is generated by the terminal H and received by the access equipment CPE1. It is assumed that the private IP address 192.168.1.56 and the port number 16587 are assigned to the WAN (for “Wide Area Network”) interface of the access equipment CPE1 in the case of a double NAT design. The NAT function of the access equipment CPE1 then replaces, in the header of the packet P of IP data received from the terminal H3, the pair (10.2.25.5,12345) by the pair (192.168.1.56,16587). It may also perform other modifications, such as for example the execution of a cyclic redundancy code (CRC, more commonly denoted by “checksum”) or the application of a function of the ALG (for “Application Level Gateway”) type. Then, the access equipment CPE1 sends the packet P′ of IP data, at least the source address field of which has been modified after execution of the NAT function, to an operator NAT CGN2. Upon receiving the packet P′ of IP data, the operator NAT CGN2 selects an external IP address (for example a public IPv4 address) and an external port number (for example a public port number) for the processing of the packet P′, for example the pair (1.2.3.4, 45875), and associates, in an information base, for example a BIB (for “Binding Information Base”), the pair (1.2.3.4, 45875) with the pair (192.168.1.56, 16587) together with the transport protocol used (not mentioned in FIG. 1 for the sake of simplicity). Then, the operator NAT CGN2 replaces, in the header of the packet P′ of IP data, the internal IP address 192.168.1.56 and the internal port number 16587 with the external IP address 1.2.3.4 and the external port number 45875, respectively. The packet P″ of IP data thus obtained is subsequently transferred by the operator NAT CGN2 to its destination (the remote equipment S4 in the figure).

It should be noted that the lack of IPV4 addresses is a problem also encountered in mobile networks, owing to the limitation of the private addressing space (18 million addresses available in total). Indeed, the current designs of mobile networks tend to almost systematically assign a private IPV4 address to each mobile terminal. The operators who implement such designs must therefore also set up mechanisms for sharing private IPV4 addresses based on the operator NATs (CGN) typically deployed within the interface Gi (sGi or N6 depending on the 3GPP release in question) allowing a mobile access network to be connected to the data network (for example, the Internet). Furthermore, conversion mechanisms of the NAT64 type may also be deployed in the networks of the operators who have defined a strategy for migration to IPV6, a protocol whose addressing space is presented as the durable solution to the lack of IPV4 addresses. Such a mechanism for translation of addresses NAT64 advantageously allows a node called IPV6-only, supporting only the IPV6 protocol, to communicate with a node called IPV4-only, supporting only the IPV4 protocol, by converting the IPV6 data packets received from the IPV6-only node into IPV4 packets before transmitting them to the IPV4-only node.

The document RFC 6269 published by the IETF lists a set of problems inherent to the address sharing solutions. Typically, in a context of mitigation of attacks, the quarantining of an IP address associated with a DDOS attack impacts all the client equipment sharing this address. The instigation of mitigation actions within a network or by a remote server thus risks impacting the quality of service experienced by all the client equipment sharing the same IP address, or even rendering the service unavailable for some of them.

### DESCRIPTION OF THE INVENTION

The invention notably allows the effectiveness of the attack mitigation policies to be improved in network environments where functions which aggregate several connections using addresses able to be shared (for example CGN or proxy functions) are deployed, by providing a method for managing, by a first device located in a network, a first set of IP addresses, this method comprising:
a step for detecting suspicious behavior associated with an IP address of the first set selected by the first device in order to process at least one data packet of a client equipment served by the first device;
following said detection, a step for executing at least one action from between:
   an adjustment of at least one sharing ratio of at least one IP address of the first set applied by the first device; and
   a request, addressed to at least a second device managing a second set of IP addresses, for delegation of at least one IP address of the second set to the first device so that the first device is able to select said at least one delegated IP address in order to process at least one data packet of at least one client equipment served by the first device.

In a correlated manner, the invention also relates to a device, referred to as first device, located in a network, this first device managing a first set of IP addresses and comprising:
a detection module, configured for detecting suspicious behavior associated with an IP address of said first set selected by the first device in order to process at least one data packet of a client equipment served by the first device;
an execution module, configured for executing following said detection, at least one action from between:
   an adjustment of at least one sharing ratio of at least one IP address of the first set applied by the first device; and
   a request, addressed to at least a second device managing a second set of IP addresses, for delegation of at least one IP address of the second set to the first device so that the first device is able to select said at least one delegated IP address in order to process at least one data packet of at least one client equipment served by the first device.

The first and second devices may typically be operator NATs (or CGNs or else LSNs) such as previously described, configured for managing pools of separate IP addresses (sets of addresses in the sense of the invention) able to be shared between several client equipments connected to a network. Both devices may be co-located or be installed on board separate equipments, be deployed within the network in a distributed or centralized manner, where the network may comprise several levels of operator NAT one after the other. The IP addresses of the same pool may be IPv4 addresses and/or IPV6 addresses, contiguous or otherwise. The invention is applicable to any type of operator NAT (for example, NAT44, NAT64, DS-lite, NPTv6 (in other words implementing a translation of IPV6 network prefixes into other IPV6 prefixes), etc.). Furthermore, no assumption is made with regard to the nature of the client equipments able to share the same IP address: these may be terminals, equipment for accessing the network of an operator such as a CPE, etc.

The invention may also be applied in other contexts, and notably to other devices managing a plurality of IP addresses able to be shared between several client equipments, such as for example to devices implementing a proxy function using its own IP addresses in order to relay data packets received. Such devices are for example described in the sections 5, 6 and 7 of the document RFC 7620 published by the IETF and entitled “Scenarios with Host Identification Complications”, August 2015. Furthermore, the invention is also applicable when the IP addresses managed by the first and/or second devices are allocated at a given time to individual client equipments, in other words to IP addresses which are not shared between several client equipments.

The IP addresses managed by the first and second devices, and also the delegated IP addresses, are used by said devices for processing data packets of client equipments. The phrase “packet of a client equipment” is understood to mean a packet (or in an equivalent manner, a message) containing data sent out by this client equipment and intended for a destination entity, or conversely, sent out by a source entity and destined for the client equipment. It should be noted that, in the sense of the invention, the packet in question may be received by the first device directly from the client equipment or may transit via one or more intermediary equipments (for example via one or more operator NATs when several levels of operator NAT are deployed in cascade in the network) before being received by the first device.

Thus, the invention provides, in order to respond effectively to the detection of suspicious behavior associated with an IP address (for example suspicious activity generated with this address as source address) in a network in which the IP addresses are able to be shared between several client equipments, the instigation of two types of actions (alternatively or in combination), namely:
modify one or more sharing ratios of addresses applied by the device (first device in the sense of the invention) managing the IP address with the suspicious behavior: typically, the first device may reduce the sharing ratio applied to the IP address with the suspicious behavior and increase that of the other IP addresses that it is managing in order to be able to assign these other IP addresses to the client equipments that it serves (current and future);
benefit from the assistance of another device (second device in the sense of the invention) and notably ask it to delegate to it one or more “healthy” IP addresses in order for it to use them to process the packets of the client equipments which are attached to it. Accordingly, the “nominal” set of the IP addresses (first set in the sense of the invention) which is assigned to the first device is de facto extended with new IP addresses.

These actions are aimed at ensuring for the first device the availability of “healthy” IP addresses (in other words with no reputation of having been used for fraudulent purposes and which are not therefore in principle targeted or used by the source of an attack) so that it is able to process the packets of client equipments coming to it, and to do this despite the malicious behavior associated with one of the active IP addresses that the first device (CGN, for example) is managing. These actions may, in one particular embodiment, have an effect for a limited period of time, for example for as long as the suspicious behavior associated with the IP address in question subsists.

By virtue of the execution of such actions, the impact of the cyber attacks on the operation of the service or services to which the users of the client equipments subscribe, which equipments could potentially share the same IP address, is reduced. It should be noted that the sharing of IP addresses is often implemented within the network without the knowledge of the users. For example, as previously mentioned, it may be set up by an operator of a network in order to overcome the lack of IPV4 addresses. The invention allows it to be ensured that this sharing of IP addresses remains transparent to the users and has no impact on the quality of service experienced by the latter. By virtue of the invention, the operator may indeed guarantee a continuity of service to the users while at the same time ensuring the effectiveness of the mitigation actions implemented in order to respond to suspicious behavior detected within the network. These mitigation actions consist, for example, in quarantining an IP address associated with suspicious behavior, where this quarantining may consist in isolating the incoming traffic destined for this IP address, and/or in rejecting connections established with this address, and/or in redirecting the traffic characteristic of the connections established with this address towards a traffic inspection module, and/or in removing this IP address from the pool of IP addresses able to be used for processing the packets of a client equipment, etc.

Thus, as can be seen in view of the above, the invention relies on the first device triggering an action in response to suspicious behavior associated with a shared IP address, but also when this action comprises a request to delegate IP addresses to the second device collaborating with the first device by responding favorably to its request.

The invention therefore, according to another aspect, also relates to a method for collaborating with a first device located in a network and managing a first set of IP addresses comprising an IP address associated with suspicious behavior, said method being intended to be implemented by a second device managing a second set of IP addresses and comprising:
a step for receiving a request, coming from the first device, for delegating at least one IP address of the second set to the first device in order for the first device to be able to select said at least one delegated IP address for processing at least one data packet of at least one client equipment served by the first device; and
a step for sending to the first device a list comprising at least one IP address of the second set delegated by said second device to the first device.

In a correlated manner, the invention is also aimed at a device, referred to as second device, located in a network, said second device managing a second set of IP addresses and comprising:
a receiver module, configured for receiving a request, coming from a first device managing a first set of IP addresses comprising an IP address associated with suspicious behavior, to delegate at least one IP address of the second set to the first device in order for the first device to be able to select said at least one delegated IP address for processing at least one data packet of at least one client equipment served by the first device; and
a transmission module, configured for sending to the first device a list comprising at least one IP address of the second set delegated by said second device to the first device.

The advantages of the collaboration method and of the second device are similar to those previously described for the management method and the first device.

The suspicious behaviors associated with IP addresses able to trigger the execution of an adjustment of a sharing ratio of IP addresses or of a request for delegation according to the invention may be of various natures; for example the suspicious behavior detected may result from the IP address belonging to a block-list, or the fact that it is associated with a low reputation level, etc. These suspicious behaviors may be detected directly (in other words locally) by the first device, or by other entities, then responsible for notifying the first device.

Thus, in one particular embodiment, the detection step may comprise the receipt of a notification generated by an attack detection function (for example installed on board an attack mitigation system or center, also denoted by AMS) or of a notification generated by a system for reputation of IP addresses.

Such a notification may for example be sent out via a DOTS (for “DDOS Open Threat Signaling”) channel established between the first device and the aforementioned attack detection function or system for reputation of IP addresses. In a manner known per se, DOTS is a client/server architecture, specified by the IETF, whose objective is to provide a mechanism for signaling the detection of suspicious traffic or of a proven attack so as to implement appropriate mitigation actions as fast as possible. Thus, the implementation of the invention may notably rely on the implementation by the first device of the mechanism described in the document RFC 9244 of the IETF entitled “Distributed Denial-of-Service Open Threat Signaling (DOTS) Telemetry”, June 2022, in order to receive notifications relating to attacks for which an IP address belonging to the first set is the target. For the attacks whose source is an IP address of the first set, it may be envisioned to specify an extension of this DOTS signaling mechanism consisting in defining a new “Uri-Query” option, called for example “source-address”, with the value of the IP address in question, as further detailed hereinbelow.

Of course, this is only one illustrative example of implementation of the invention, and other mechanisms for notification of the first device may be envisioned.

As previously mentioned, the invention is applicable in various contexts.

Thus, in one particular embodiment, it may be envisioned for the first device to be configured with a list of second devices according to the invention with which it may envision a collaboration and, more particularly, to which it may send a request for delegation of IP addresses.

In another embodiment, the management method may comprise a step for discovering said at least a second device.

Such a dynamic discovery of the devices able to delegate IP addresses to it may be implemented by the first device for example using a dynamic routing protocol such as OSPF (for “Open Shortest Path First”), or by interrogating a network function of the NRF (for “Network Repository Function”) type in a 5G network.

In one particular embodiment, the management method may furthermore comprise a step for establishing with said at least a second device at least one communication channel, for example an encrypted communication channel. This communication channel may be established so as to be used in a unidirectional manner by the first device for sending a delegation request to the second device, or in a bidirectional manner, each of the first and second devices being able to use this channel in either direction for sending a delegation request.

The communication channel established between the first device and a said second device may notably be an encrypted communication channel relying for example on the QUIC protocol and potentially, as the case may be, on the definition of a new transport parameter allowing the first device and the second device to be informed on their respective support of the mechanism provided by the invention (and in particular of the delegation of IP addresses).

The QUIC protocol advantageously allows an encrypted communication channel, hence secure between the two devices, to be established; according to the QUIC protocol, not only the useful data exchanged by the first and second devices are encrypted but also most of the control data, which provides an additional protection against potential attacks. This is however one simple example of implementation of the invention, and other mechanisms may be envisioned. For example, the communication channel may rely on a GRE (for “Generic Routing Encapsulation”) or IPsec (for “IP security”) tunnel, or may be based on the IP-in-IP protocol. It should be noted that the establishment of an encrypted communication channel advantageously allows the security of the mechanism provided to be reinforced, notably if a device (or node) of the network is compromised. It is, however, possible to forego such an encryption if it is considered that all the devices of the network are trustworthy.

The discovery step and/or the step for establishing a channel for communicating with a second device may be implemented before or after the detection step. In other words, these steps may be triggered by the detection of suspicious behavior associated with an IP address, so as to notably reduce the resources monopolized for the implementation of the invention, or be carried out in a prior step, independently of any detection of suspicious behavior associated with an IP address managed by the first device, so as to reduce the reaction time of the first device when faced with suspicious behavior associated with an IP address that it is managing.

The establishment of a communication channel between the first device and a second device allows the devices to exchange various types of information useful for their collaboration.

Thus, in one particular embodiment, the delegation request addressed by the first device may comprise a number and/or a type of delegated IP addresses desired by the first device.

In another embodiment, the management method furthermore comprises a step for receiving by the first device, in response to a said delegation request addressed by the first device to a said second device, at least one element from amongst:
a list comprising at least one IP address delegated by this second device to the first device;
a period of time during which said list is delegated to the first device;
information representative of a maximum volume of traffic, associated with the usage of an IP address delegated by said at least a second device to the first device and which may be managed by the second device.

These various types of information allow the collaboration between the two devices to be made more efficient and better adapted to the needs of the first device and/or to the capacities of the second device. They are not limiting per se, and other information may be exchanged between the devices.

The information representative of the maximum volume of traffic transmitted by the second device may be exploited by the first device so as to use in an optimized manner the IP addresses that are delegated to it and to best distribute the traffic transiting via it.

For example, in one particular embodiment, the management method comprises a step for selecting at least two IP addresses delegated by said separate second devices for processing packets of at least two separate client equipments served by the first device.

Thus, in this embodiment, the first device may distribute all or part of the traffic transiting via it and associated with separate client equipments between several IP addresses delegated by said separate second devices. This embodiment has a preferred application when, for example, one of said second devices is not able to process all the traffic in question. The first device may then make use of other devices for processing the excess of traffic with respect to the maximum volume of traffic indicated by said second device with insufficient capacity.

In one particular embodiment, the management method furthermore comprises:
a step for receiving, from an internal source IP address, a first data packet comprising data intended for a destination entity;
a step for replacing this internal source IP address with a said IP address delegated by a said second device to the first device and selected by the first device for processing the first data packet; and
a step for transmitting the data with the delegated IP address to said second device, via a communication channel established with it, so that said data is routed toward the destination entity.

Similarly, in one particular embodiment, the management method may furthermore comprise:
a step for receiving, via a channel for communicating with a said second device, a second data packet sent out by a transmitting entity and comprising data destined for an IP address of the second set of IP addresses managed by the second device; and
if said IP address is delegated to the first device by the second device and selected by the first device for processing data packets of a client equipment served by the first device, a step for transmitting said data to an internal IP address allocated to said client equipment.

In a correlated manner, in one particular embodiment, the collaboration method furthermore comprises:
a step for receiving, via a communication channel established with the first device, a first data packet comprising data destined for a destination entity and transmitted with a source IP address belonging to the second set of IP addresses managed by the second device; and
if said source IP address is a said IP address delegated by the second device to the first device, a step for transmitting said data to the destination entity without modifying said source IP address of said data.

Furthermore, in another embodiment, the collaboration method may also comprise:
a step for receiving a second data packet comprising data sent out by a transmitting entity and destined for a destination IP address belonging to the second set of IP addresses managed by the second device; and
if said IP address is a said IP address delegated by the second device to the first device, a step for transmitting said data to the first device via the communication channel established with said first device without modifying said destination IP address of said data.

These embodiments of the management method and of the collaboration method have a preferred application when the first and second device in question are operator NATs. In these embodiments, the data packets sent out by or destined for the client equipment (denoted as data packets of the client equipment), to which the first device assigns an IP address delegated by a said second device, transit via a communication channel (potentially secure) established between the first and the second device. It should be noted that when the data packets associated with an IP address delegated by the second device to the first device arrive at the second device, the latter does not carry out any modification of the delegated IP address in question (no translation of addresses), given that this is an address belonging to the pool of addresses that it is managing. In other words, it disables the address translation function that it usually applies to the packets which transit via it.

Advantageously, these embodiments do not require any modification of the routing policies set up within the network, nor of the routing policies for the traffic transiting via the first and second devices. Indeed, these embodiments do not require synchronization of the routing tables of the network equipment linked to the delegation of IP addresses and, consequently, allow the impact of the convergence time associated with the synchronization of the routing tables held by the network equipment to be avoided. The implementation of the invention does not therefore impact the stability of the routes installed within the network. Once the delegation of IP addresses has been accepted by the second device, the delegated IP addresses may be used without delay by the first device for processing the packets sent out by or destined for the client equipments which arrive at the device.

In another embodiment, it may be envisioned to modify the routing tables in order to ensure that the data packets associated with an IP address delegated by a said second device to the first device are directly routed to the first device without transiting via the second device. In this other embodiment, the communication channels established, as the case may be, between the first and second devices are only used for the control needs (for example for a request to delegate addresses) or for the routing of data during the time needed for the convergence of the routing.

In one particular embodiment, the management and collaboration methods are implemented by a computer.

The invention is also aimed at a computer program on a recording medium, this program being able to be implemented in a computer or, more generally, in a first device according to the invention and comprising instructions adapted to the implementation of a management method such as described hereinabove.

The invention is also aimed at a computer program on a recording medium, this program being able to be implemented in a computer or, more generally, in a second device according to the invention and comprising instructions adapted to the implementation of a collaboration method such as described hereinabove.

Each of these programs may use any given programming language and take the form of source code, object code, or of code intermediate between source code and object code, such as in a partially compiled form, or in any other desired form.

The invention is also aimed at an information medium or a recording medium readable by a computer, and comprising instructions of a computer program such as mentioned hereinabove.

The information or recording medium may be any given entity or device capable of storing the programs. For example, the medium may comprise a storage means, such as a ROM, for example a CD ROM or a microelectronic circuit ROM, or else a magnetic recording means, for example a hard disk, or a flash memory.

On the other hand, the information or recording medium may be a transmissible medium such as an electrical or optical signal, which may be routed via an electrical or optical cable, via wireless radio or optical link or by other means.

The program according to the invention may, in particular, be up/downloaded over a network of the Internet type.

Alternatively, the information or recording medium may be an integrated circuit in which a program is incorporated, the circuit being designed to execute or to be used in the execution of the management and collaboration methods according to the invention.

According to yet another aspect, the invention is also aimed at a system, at least a first device according to the invention and at least a second device according to the invention, configured for processing at least one request for delegation of IP addresses received from a said first device.

The system benefits from the same advantages previously mentioned as the first and second devices.

It may also be envisioned, in other embodiments, for the management and collaboration methods, the first and second devices and the system according to the invention to exhibit in combination all or part of the aforementioned features.

### BRIEF DESCRIPTION OF THE DRAWINGS

Other features and advantages of the present invention will become apparent from the description presented hereinbelow, with reference to the appended drawings which illustrate one exemplary embodiment of the invention and which is in no way limiting. In the figures:

FIG. 1, already described, shows translations of addresses performed by an equipment for accessing a network with an onboard NAT function and an operator NAT (CGN) deployed within the network;

FIG. 2 shows a system according to the invention within its environment, in one particular embodiment;

FIG. 3 shows one example of hardware architecture of a computer hosting a first device and/or a second device of the system in FIG. 2;

FIG. 4 shows the functional modules of a first device and of a second device of the system in FIG. 2, according to the invention, in one particular embodiment;

FIG. 5 shows the main steps of a management method according to the invention such as they are implemented by a first device of the system in FIG. 2;

FIG. 6 shows the main steps implemented by the first device in FIG. 2 when, in response to suspicious behavior associated with an IP address that it is managing, it executes an action consisting in addressing a request to delegate at least one IP address to a second device of the system in FIG. 2;

FIG. 7 shows the main steps implemented by a second device of the system in FIG. 2, requested by the first device of said system in order to delegate to it IP addresses;

FIG. 8 shows, by an illustrative example, the processing operations carried out in the context of the invention by the first and second device of the system in FIG. 2 on messages from client equipments served by the first device;

FIG. 9 shows one example of a system according to the invention serving a client equipment of the CPE type;

FIG. 10 illustrates a network comprising several levels of operator NAT, each level of operator NAT including a system according to the invention.

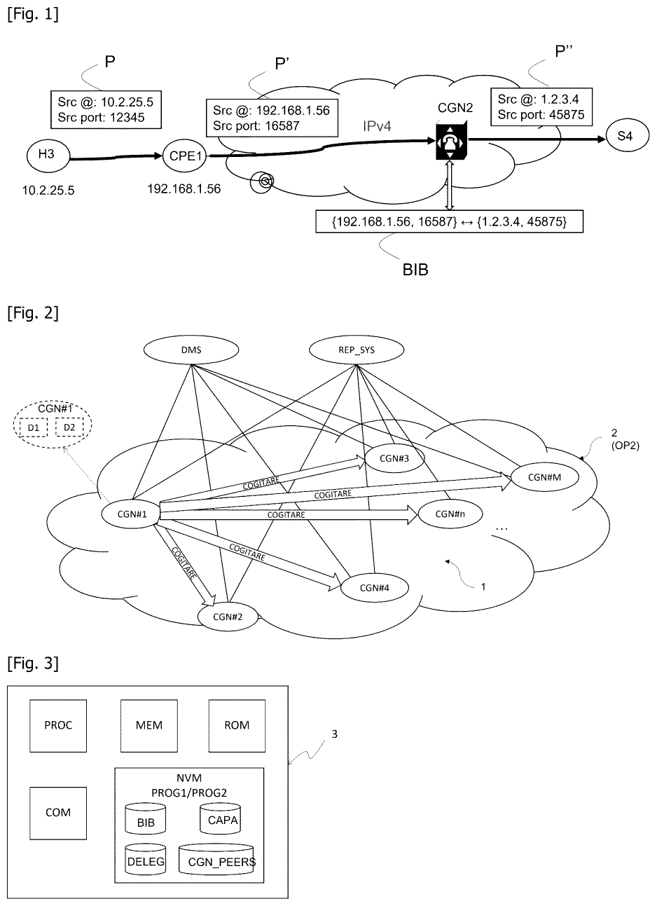

### DESCRIPTION OF EMBODIMENTS OF THE INVENTION

FIG. 2 shows, in its environment, a system 1 according to the invention, in one particular embodiment in which it is located in a communications network 2 managed by an operator OP2. No assumption is made with regard to the nature of the network 2, which may be fixed or mobile.

The network 2 comprises a plurality of operator NATs or CGNs (or in an equivalent manner, a plurality of instances of operator NAT or of CGN), deployed on separate equipments, and referenced CGN #1, CGN #2, . . . , CGN #M, where M denotes an integer number greater than 1. Each operator NAT CGN #n, n=1, . . . ,M disposes of at least one external IP address (for example public) denoted @IP-CGN #n which has been allocated to it by the operator OP2.

In the embodiment described here, it is assumed that the network 2 is configured to use the IPV4 protocol and that each operator NAT CGN #n, n=1, . . . ,M is of the NAT44 type, such as described in the document RFC 3032 published by the IETF and entitled “Traditional IP Network Address Translator (Traditional NAT)”, January 2001. Each operator NAT CGN #n, n=1, . . . ,M, is configured with a dedicated and distinct set (or pool) of external IPv4 addresses (for example public), denoted POOL #n, that it is managing and may use for processing the data packets that it receives, these packets comprising data sent out by or destined for client equipments of the network 2.

The IPV4 addresses of a set of addresses POOL #n may be contiguous (for example 1.2.3.0/24) or otherwise (for example 1.2.3.4/32 and 11.25.25.36/32). It is assumed that routes are announced within and outside of the network 2 so that the traffic destined for an IP address of a set POOL #n is received by the operator NAT CGN #n to which this set of addresses is assigned. For the sake of simplicity, the assumption is made, in the embodiment described here, that the network 2 implements a single level of operator NAT, in other words that the packets of the client equipments of the network 2 are only processed, in the sense of the translation of addresses, by a single operator NAT from amongst the operator NATs CGN #n, n=1, . . . ,M.

The IPV4 addresses of each set POOL #n assigned to an operator NAT CGN #n may, in the embodiment described here, be shared between several client equipments served by the operator NAT CGN #n. The phrase “client equipment served by an operator NAT” (or in an equivalent manner here, “client equipment attached to or managed by an operator NAT”) is understood to mean that the operator NAT is responsible for the processing of the data packets of this client equipment (in other words comprising data sent out by or destined for this client equipment), and notably for the translation of the IP addresses transported within these packets, in other words the translation of an address said to be “internal” into an address said to be “external” (or vice versa depending on the direction of communication in question).

It should be noted that a client equipment is not necessarily aware of the operator NAT designated to serve it. Similarly, the operator NAT CGN #n does not necessarily have an explicit knowledge of the client equipment to which a packet that it has to process relates and which is transported using an internal IP address (the information relating to the client equipment may however be known if a mechanism such as described for example in the document RFC 7785, entitled “Recommendations for Prefix Binding in the Context of Softwire Dual-Stack Lite”, February 2016, is implemented by the operator NAT). It exploits the “internal” IP address used for transporting this packet to it in order to translate it into an “external” IP address of the set POOL #n. Irrespective of the mode of operation of the operator NAT CGN #n, this still nevertheless results in the operator NAT CGN #n being able to select, for processing the packets of several separate client equipments, the same IPv4 external address from amongst the external IPv4 addresses of the set POOL #n that it is managing.

In the following part of the description, for the sake of simplicity, the notions of “internal/external address” for qualifying the IP addresses in question are sometimes omitted, except where these addresses need to be distinguished. Indeed, these notions are relative and defined with respect to the operator NAT in question: at a given level of operator NAT, an internal IP address transported by a packet sent out by a client equipment is translated into an external IP address (and vice versa, depending on the direction of communication in question). However, when two levels of operator NAT are envisioned, an operator NAT of the first level carries out a translation of an internal address such as it appears in the header of a packet sent out by a client equipment into an external address, but this external address is considered as an internal address from the point of view of an operator NAT of the second level.

No assumption is made as regards the nature of the client equipments to which the invention is applicable. These may be terminals (for example smartphones, tablets, computers), equipment for access from a LAN (for “Local Area Network”) to the network 2 (for example CPEs to which terminals are connected), etc. By way of illustration, in the embodiment illustrated in FIG. 2, the client equipments served by the operator NAT CGN #n, n=1, . . . ,M are terminals.

The criteria for selection and use of an IP address (then said to be “active”) of a set POOL #n are specific to each operator NAT; each operator NAT decides locally (typically according to its configuration) on the way in which the active IP addresses of the set that has been assigned to it are managed. For example, an operator NAT CGN #n, n=1, . . . ,M can decide on the number of IP addresses to be used from amongst those of the set of addresses POOL #n that it is managing according to the sharing ratio or sharing ratios with which it has, as the case may be, been configured and to the number of active client equipments (in other words having an active connection, represented in a database or a BIB table held by the operator NAT CGN #n, as previously mentioned) that it serves. The same sharing ratio (here denoted “1:x” for indicating that the same IP address may be shared between x client equipments or, more generally, that the same external IP address may be shared between x internal IP addresses in view of the previous remark) may be applied by the operator NAT CGN #n to each (external) IP address intended to be shared. As a variant, it may be envisioned to apply different sharing ratios according to the IP addresses or according to other criteria (for example geographical considerations). It may also be envisioned to only share certain IP addresses, etc.

The criteria for attaching a group of client equipments to a given operator NAT CGN #n are known to those skilled in the art and are not detailed here; they come from the know-how of the user of the operator NAT CGN #n, n=1, . . . ,M, namely here the operator OP2 of the network 2. The same is true for the manner in which the operator NATs CGN #n, n=1, . . . ,M are placed on the paths taken by the communications established by the client equipments that they serve.

The assumptions previously mentioned are not limiting per se. The invention may also be applied in other contexts, and notably to IPV6 addresses, to other types of operator NAT (for example NAT64, DS-Lite, NPTv6), where the operator NATs of the network 2 may all be of the same type or of different types, co-located or deployed on separate hardware equipment, or else virtualized and hosted in infrastructures of the cloud type. Furthermore, the operator NATs may be deployed in a distributed manner within the network 2 (with (instances of) operator NATs deployed as close as possible to client equipments) or in a centralized manner. Several levels of operator NATs may also be envisioned, in other words a packet of a client equipment of the network 2 may be subject to successive translations of addresses carried out by operator NATs deployed on several levels within the network 2.

Here, for the sake of simplicity, it is assumed that the set of the operator NATs CGN #n, n=1, . . . , M deployed within the network 2 belong to the system 1, and that each operator NAT CGN #n, n=1, . . . , M carries various modules configured for implementing, depending on the context in which the operator NAT CGN #n is situated, a management or a collaboration method according to the invention. In other words, each operator NAT CGN #n, n=1, . . . ,M carries the functional modules of a first device D1 according to the invention, able to detect suspicious behavior associated with an IP address that it is managing, and the functional modules of a second device D2 according to the invention, able to collaborate with other operator NATs of the system 1 (in FIG. 2, for the sake of simplicity, the devices D1 and D2 have only been shown for the operator NAT CGN #1); depending on of the context, the operator NAT CGN #n activates the functional modules of one or the other of the devices D1 and D2 that it is carrying. In the embodiment described here, the same operator NAT CGN #n of the system 1 may therefore sometimes be a first device according to the invention, or other times a second device according to the invention.

It goes without saying that this assumption is not limiting per se and other configurations may be envisioned for the system 1. For example, the system 1 may only integrate a sub-set of the operator NATs of the network 2, and the operator NATs in question may only carry the functional modules of a first device D1 according to the invention or only the functional modules of a second device D2 according to the invention, it being understood that, amongst the operator NATs of the system 1, there is at least a first device D1 and at least a second device D2 according to the invention.

Furthermore, each operator NAT CGN #n, n=1, . . . , M of the system 1 disposes of a communication channel (for example here a DOTS channel) established with at least one function (or one system) for detecting attacks, known per se and not described in detail here. The operator NATs CGN #n, n=1, . . . ,M of the system 1 may make use of one or more separate functions for detecting attacks via the DOTS channels thus established. In the example in FIG. 2, attacks of the DDOS type are considered, and the function or functions for detecting attacks with which the operator NATs CGN #n, n=1, . . . ,M, establish DOTS channels are centers for DDOS or DMS mitigation. Of course, the invention is applicable to other types of cyber attacks and to other functions/systems for detecting attacks (for example, more generally, to AMS centers).

Each DOTS channel thus established allows each operator NAT CGN #n, n=1, . . . ,M to receive from the DMS centers information relating to the DDOS attacks whose source or destination is an address of the set POOL #n of IP addresses that it is managing. More particularly:
in order to receive, via such a DOTS channel, notifications from a DMS center relating to attacks, the target of which is an IP address of the set POOL #n, the operator NAT CGN #n is configured here to use a mechanism for subscribing to the DMS center such as that described in the aforementioned document RFC 9244, notably at the point 8.1.1;
in order to receive, via such a DOTS channel, notifications from a DMS center relating to attacks the source of which is an IP address of the set POOL #n, a new extension to the mechanism described in the document RFC 9244 may be specified. The new extension provided consists in defining a new option “Uri-Query>, called for example “source-address”, allowing the operator NAT CGN #n to indicate, in a request addressed to the DMS center, the addresses of the set POOL #n for which it wants to be notified. Table 1 illustrates one example of such a request including the new “source-address” option informed with the IP address “1.2.3.4”.

TABLE 1

Header: GET (Code=0.01)
Uri-Path: “.well-known”
Uri-Path: “dots”
Uri-Path: “tm”
Uri-Path: “cuid=dz6pHjaADkaFTbjr0JGBpw”
Uri-Query: “source-address=1.2.3.4”
Observe: 0

The notifications sent by a DMS center to the operator NAT CGN #n may be generated by the DMS center following a local detection or following the receipt by the DMS center of a notification coming from other entities (for example from another DMS center).

In the embodiment described here, a DOTS channel is also established between each operator NAT CGN #n, n=1, . . . ,M of the system 1 and a reputation system REP_SYS. This DOTS channel is established for example here using a configuration request characteristic of the RESTCONF protocol. This request comprises a subscription filter conditioning the notifications sent by the reputation system REP_SYS to the operator NAT CGN #n. The subscription filter denotes for example all or part of the IP addresses of the set POOL #n managed by the operator NAT CGN #n.

In a known manner, such a reputation system REP_SYS is designed to evaluate a level of reputation of an IP address, this reputation level reflecting the degree of confidence that may be assigned to this IP address. It is established by collecting specific data from various entities (for example a router of the network), such as for example the volume of suspicious traffic associated with the IP address, its potential inclusion in a “block-list”, its potential implication in cyber attacks, etc. The higher the level of reputation of an IP address, the more its behavior is considered as secure. Conversely, a low level of reputation (typically less than a certain threshold) corresponds to a high risk of malicious behavior associated with the use of the IP address (and hence of the traffic sent out with such an address as source address). The DOTS channel established between an operator NAT CGN #n and the reputation system REP_SYS thus allows the operator NAT CGN #n to obtain the levels of reputation determined by the reputation system REP_SYS for the IP addresses of the set POOL #n that the operator NAT CGN #n manages.

It should be noted that the DMS centers and the reputation system may be used by the same administrative entity (for example by the operator OP2 managing the operator NAT CGN #n, n=1, . . . ,M) or by separate administrative entities. Furthermore, no assumption is made as regards the location of these systems. Notably, the same hardware equipment may carry the reputation system REP_SYS and a DMS center.

In the embodiment described here, the operator NATs CGN #n, n=1, . . . ,M are hosted by equipment having the hardware architecture of a computer 3 such as shown in FIG. 3.

Each computer 3 comprises a processor PROC, a volatile memory MEM, a read-only memory ROM, a non-volatile memory NVM, and communication means COM, allowing the operator NATs CGN #n, n=1, . . . , M to communicate notably with other entities of the network 2 (and more particularly to communicate with one another), with the DMS centers and the reputation system REP_SYS, and also with the client equipment that they serve. Such means of communication are known per se and are not described in detail here.

The non-volatile memory NVM of the computer 3 constitutes a recording medium according to the invention, readable by the processor PROC and here on which computer programs PROG1 and PROG2 according to the invention are recorded.

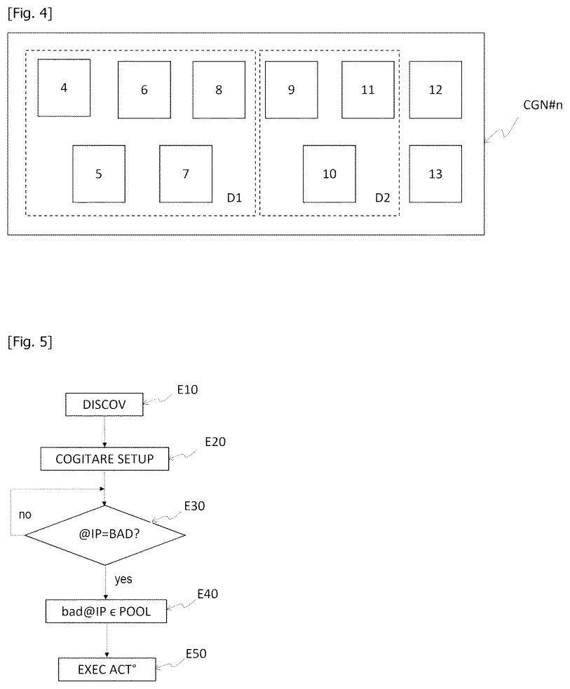

More specifically, the computer program PROG1 comprises instructions defining the main steps of a management method according to the invention. It defines functional modules of a first device D1 according to the invention, and incidentally, in the embodiment described here, of each operator NAT CGN #n, n=1, . . . ,M. These functional modules support or control the aforementioned elements PROC, MEM, ROM, NVM, and COM of the computer 3, and here comprise, for each operator NAT CGN #n, as illustrated by FIG. 4:
a detection module 4, configured to detect suspicious behavior associated with an active IP address of the set POOL #n managed by the operator NAT CGN #n, selected by the latter for processing at least one packet of a client equipment served by the operator NAT CGN #n; and
an execution module 5, configured for executing at least one action in reaction to the suspicious behavior detected by the detection module 4. More particularly, in the embodiment described here, the execution module EXEC is configured for choosing the action or actions to be executed from amongst a given set ACT of actions, comprising at least the following actions:
   an action ACT1 consisting in removing the IP address associated with suspicious behavior from the set POOL #n of IP addresses able to be selected by the operator NAT CGN #n for processing the packets of the client equipments that it serves (where this removal may only concern the connections likely to be established in the future by a client equipment, but also the current connections (in other words active, such as shown in the BIB table held by CGN #n));
   an action ACT2 consisting in adjusting at least one sharing ratio of at least one IP address of the set POOL #n; and
   an action ACT3 consisting in requesting a delegation of IP addresses to at least one other operator NAT CGN #j of the system 1, with j #n. Here, delegation is understood to mean that the operator NAT CGN #j accepts to assign one or more IP addresses from its set POOL #j to the operator NAT CGN #n so that the latter is able to use it or them for processing packets of client equipments which are attached to it.

The choice of the action or of the actions executed by the execution module 5 may depend on the context (for example on the nature of the malicious behavior detected, on the number of active connections processed by the operator NAT CGN #n, on the effective sharing ratio of the IP addresses of the set POOL #n that it is managing, on the gravity of the attack, etc.). In the embodiment described here, the module 5 is configured for choosing, in response to suspicious behavior associated with an IP address, at least one action from between the action ACT2 of adjusting at least one sharing ratio and the action ACT3 of a delegation request. Other actions may of course be selected by the module 5 in addition to one of these two actions, and other actions may be considered in the set ACT taken into account by the execution module 5.

The program PROG1 here also defines three other modules of the operator NAT CGN #n as first device D1 according to the invention, namely:
a discovery module 6, configured for discovering the operator NATs of the system 1 able to collaborate with the operator NAT CGN #n and, in particular, to delegate IP addresses to it;
an establishment module 7, configured for establishing communication channels with all or part of the operator NATs thus discovered; and
a transmission/receiver module 8 for transmitting data. This module 8 is notably configured for transmitting and/or receiving data via the communication channels established by the establishment module 7 and for transmitting and/or receiving data packets to/from client equipments served by the operator NAT CGN #n.

The modules 4 to 8 are described in more detail later on with reference to the steps of the management method according to the invention.

The computer program PROG2 stored in the non-volatile memory NVM of the computer 3 comprises instructions defining the main steps of a collaboration method according to the invention. It defines functional modules of a second device D2 according to the invention, and incidentally, in the embodiment described here, of each operator NAT CGN #n, n=1, . . . ,M. These functional modules support or control the aforementioned elements PROC, MEM, ROM, NVM, and COM of the computer 3 and here comprise, for each operator NAT CGN #n, as illustrated in FIG. 4:
a receiver module 9, configured for receiving a request, coming from another operator NAT CGN #k of the system 1, with ken, to delegate at least one IP address of the set POOL #n of IP addresses managed by the operator NAT CGN #n; and
a transmission module 10, configured for sending to the operator NAT CGN #k a list comprising at least one IP address of the set POOL #n that the operator NAT CGN #n accepts to delegate to it.

Here, the program PROG2 also defines a data transmission/receiver module 11.

The modules 9 to 11 of the operator NAT CGN #n are described in more detail later on with reference to the steps of the collaboration method according to the invention.

It should be noted that, aside from the modules 4 to 11 which have just been mentioned, each operator NAT CGN #n also disposes of a module 12 for managing the set POOL #n of IP addresses assigned to it and of an address translation module 13. Functions other than the translation of addresses may of course be implemented by the operator NAT CGN #n (for example an ALG function, etc.), however these functions are not considered here for the sake of simplicity.

The management module 12 is notably responsible for selecting an “external” IP address from amongst the set POOL #n (potentially completed by the IP addresses that are, where relevant, delegated to it) for processing each packet that it receives from a client equipment carrying an “internal” IP address, and for complying with the sharing ratio or sharing ratios of IP addresses with which it has been configured. The external IP address selected for processing a packet from a client equipment is stored in memory by the management module 12 in association with the internal IP address, in the BIB table held by the operator NAT CGN #n, and here stored in the non-volatile memory NVM of the operator NAT CGN #n. As previously mentioned, the management module 12 may associate the same external IP address of the set POOL #n with several separate internal IP addresses, conforming to a sharing ratio with which it has potentially previously been configured.

The module 13 for translation of addresses is configured for processing the packets from client equipments received by the operator NAT CGN #n and, as the case may be, for translating the IP addresses of these packets in accordance with the information stored in the BIB table. The structure of the BIB table, its supply and its maintenance, together with the processing of the packets from the client equipments served by the operator NAT CGN #n in accordance with the information retained in the BIB table are known per se and are not further considered here.

When the same external IP address is shared between several client equipments, several entries in the BIB table associate this external IP address with several separate internal IP addresses. In order to allow the translation module 13 to associate the correct internal IP address with a data packet that it receives, various techniques may be envisioned in a manner known per se. For example, the differentiation may be applied on the basis of a state held by the operator NAT CGN #n in a local table (a port number associated with the internal IP address in the BIB table, an identifier of the client equipment, a transport protocol, etc.), or by implementing an algorithm designed for this purpose (for example, for an operator NAT of the NPTv6 type), etc.

The main steps of a management method according to the invention will now be described, with reference to FIG. 5, such as they are implemented by each operator NAT CGN #n of the system 1 when it acts as a first device D1 according to the invention, in other words when it detects a malicious behavior associated with an IP address that it is managing.

In the embodiment described here, each operator NAT CGN #n, n=1, . . . ,M of the system 1 first of all carries out the discovery, via its discovery module 6, of the other operator NATs CGN #j, with j=1, . . . ,M and j #n, of the system 1 (step E10). For this purpose, the discovery module 6 may use a dynamic routing protocol such as the OSPF protocol or, in the context of a network 2 of the 5G type, interro-gate the NRF function of the network 2, etc.

Then, each operator NAT CGN #n, n=1, . . . ,M of the system 1 establishes, by means of its establishment module 7, a communication channel with each of the operator NATs discovered during the discovery step E10 (step E20). In the following part of the description, these communication channels are called COGITARE (for “Collaborative cGns for advanced Ip network repuTAtion safeguard/softEnings”) channels. They may be established so as to be used in a unidirectional manner (only the operator NAT responsible for the establishment of the channel can use the channel for sending a delegation request as described hereinbelow) or a bidirectional manner (each operator NAT at one end of the channel may send a delegation request to the other operator NAT).

In the embodiment described here, these COGITARE channels are encrypted and rely on the QUIC protocol, notably described in the document RFC 9000 of the IETF entitled “QUIC: A UDP-Based Multiplexed and Secure Transport”, May 2021. As a variant, the COGITARE channels may rely on a protocol other than QUIC, for example on the IP-in-IP protocol allowing IP packets to be encapsulated within other IP packets with the establishment of tunnels (or “tunneling”). These channels may forego encryption if the operator NATs are considered as trustworthy entities, for example.

In order to implement the invention in the context of the QUIC protocol, a new transport parameter is defined, called for example “delegate_resources_enable”. Here, the value of this parameter is set at 1 by an operator NAT when the latter is configured for implementing a collaboration method according to the invention, in other words it is capable of delegating IP addresses from the pool of addresses that it is managing to another operator NAT of the system 1. It should be noted that this capability does not presume effective availability of IP addresses to be delegated for the operator NAT in question, but only of its capacity, under the assumption where such IP addresses would be available in the pool of addresses that it is managing to delegate such IP addresses, in other words of its capacity to implement the collaboration method according to the invention and to act as a second device according to the invention. Thus, it is assumed that, when an operator NAT CGN #n initializes the establishment of a COGITARE channel with another operator NAT CGN #j, jn, it inserts into the QUIC frame that it sends the parameter “delegate_resources_enable” set to a value of 1. It should be noted that this parameter may additionally be used by an operator NAT for signaling to another operator NAT that, in addition to being configured for implementing a collaboration method according to the invention, it is also configured for implementing a management method according to the invention, in other words where the need may arise for it to ask the other operator NAT to delegate IP addresses to it. This additional information may be transmitted for the purposes of information, and may be used by the other operator NAT for performing a check, where appropriate, if it receives a delegation request from this operator NAT (for example for determining whether this delegation request is coherent with what the operator NAT had told it).

If the operator NAT CGN #j with which the operator NAT CGN #n tries to establish a COGITARE channel is not capable of collaborating with another operator NAT of the system 1 and of delegating at least one IP address to it, it responds with a QUIC frame in which the parameter “delegate_resources_enable” is set to a value 0, or with a QUIC frame not containing this parameter. In this case, the procedure for establishment of a COGITARE channel is prematurely terminated and no COGITARE channel is established.

Conversely, if the operator NAT CGN #j with which the operator NAT CGN #n tries to establish a COGITARE channel is capable of delegating one or more of the IP addresses that it is managing, it responds with a QUIC frame in which the parameter “delegate_resources_enable” is set at a value of 1, and the COGITARE channel is established according to the principles defined by the QUIC protocol.

Here, the operator NAT CGN #n stores in a table CAPA, saved in the non-volatile memory NVM, for each operator NAT CGN #j requested by the operator NAT CGN #n to establish a COGITARE channel, its capability or otherwise to delegate IP addresses. This amounts to storing in the table CAPA the value of the parameter “delegate_resources_enable” returned or deduced from the QUIC frame sent by the operator NAT CGN #j in response to the request to establish a COGITARE channel from the operator NAT CGN #n. The operator NAT CGN #n may furthermore store in the table CAPA other information relating to each operator NAT CGN #j requested, such as for example one or more IP addresses allowing it to be contacted.

It goes without saying that the values 1 and 0 provided for the parameter “delegate_resources_enable” are only given by way of illustration and are not limiting per se and other values may be envisioned to indicate whether an operator NAT is capable or otherwise of delegating IP addresses to another operator NAT. Furthermore, the parameter “delegate_resources_enable”, irrespective of its value, may be exchanged between the operator NATs at any time (during the attempt to establish the COGITARE channel as previously described, or later on once the channel has been established).

It is assumed now that one of the operator NATs of the system 1, for example the operator NAT CGN #1 by way of example, detects by means of its detection module 4 suspicious behavior associated with an IP address of the set POOL #1 of IP addresses that it is managing (response YES at the test step E30). The term “suspicious behavior” here is understood to mean that the behavior associated with the IP address in question, denoted bad@IP in the following, is not normal and forewarns that the IP address is being used for malicious purposes (for example it is associated with suspicious activity) or targeted by an attack.

The detection of such suspicious behavior may be carried out by various means.

For example, the detection module 4 of the operator NAT CGN #1 may receive a notification from the reputation system REP_SYS indicating to it a reputation level of the address bad@IP lower than a given threshold, with which CGN #1 has previously been configured and below which the behavior associated with the use of the IP address is considered as malicious or at the very least suspicious.

According to another example, the detection module 4 may receive a notification from an attack detection function of a DMS center (or more generally of an AMS center) indicating to it that the address bad@IP belongs to a black list of IP addresses considered as being associated with malicious actions or that the address bad@IP has been identified as a target or used as the origin of an attack.

It should be noted that the notifications from the system REP_SYS or from the DMS center may be aimed at a domain name, in which case the detection module 4 is configured for carrying out the resolution of this domain name with a view to obtaining the corresponding address bad@IP.

According to yet another example, the detection module 4 may integrate an attack detection function and determine locally itself that the address bad@IP is associated with suspicious behavior. These examples are given solely by way of illustration and are not limiting for the invention.

Following this detection, CGN #1 verifies here that the address bad@IP indeed belongs to the set POOL #1 of IP addresses assigned to it (which is the case here) (step E40). As the case may be, it activates its execution module 5 for executing at least one action in response to this detection. It should be noted that the verification step E40 is optional (if it is not implemented, the execution module 5 is activated upon detection by the module 4 of the suspicious behavior associated with the address bad@IP).

The action or the actions then executed by the execution module 5 may be selected by the latter depending on the context. As previously mentioned, in the first embodiment described here, the execution module 5 chooses to execute at least one action from amongst the set ACT of actions comprising:
the action ACT1 consisting in removing the address bad@IP from the IP addresses of the set POOL #1 able to be selected by CGN #1 for processing the packets of the client equipments that it serves (denoted more simply in the following by “active IP addresses”). It should be noted that this removal may relate only to the future connections able to be established by client equipments (typically the packets relating to client equipments other than those already served by CGN #1 at the time of the removal), and/or also the active connections (in other words in progress). The choice of one or the other of the strategies may result from a policy of the operator OP2, may differ depending on the context (for example on the location of the source of the attack), etc. For example, keeping the address bad@IP for processing the packets characteristic of active connections may be justified when the source of an attack is internal to the network 2, and/or in order to avoid having to migrate all the client equipments served with the address bad@IP by CGN #1;
the action ACT2 consisting in adjusting at least one sharing ratio of at least one IP address of the set POOL #1; for example, at least one sharing ratio may be increased if the operator NAT CGN #1 no longer disposes of IP addresses to be able to serve the client equipments attached to it (for example in order to go from 1:10 to 1:20 or from 1:2 to 1:5). This dynamic adjustment of at least one sharing ratio advantageously allows the malicious behavior associated with the address bad@IP to be compensated and, in particular, its removal, where necessary, from the active IP addresses if the action ACT1 is also executed. It should be noted that such a dynamic adjustment may globally relate to the sharing ratio of all the IP addresses of the pool POOL #1 (with the exception of the sharing ratio of the address bad@IP, which may on the contrary be reduced or even unused in the case of removal), or be applied in a differentiated manner to only a part of the IP addresses of the pool POOL #1. Furthermore, a sharing ratio may be adjusted several times if needs be (for example if several notifications signaling the suspicious behavior of several separate IP addresses are received by the detection module 4); and
the action ACT3 consisting of a request for delegation of IP addresses addressed to at least one other operator NAT CGN #j of the system 1, with j #1. The action ACT3 may notably be selected
by the execution module 5 when the sharing ratios of the active IP addresses of the set POOL #1 (distinct from the address bad@IP associated with suspicious behavior) have reached a maximum value, defined for example by the operator OP2, then rendering impossible the selection of the action ACT2. This is however only one illustrative example, and the action ACT3 may be selected by the execution module 5 in other contexts.

In the embodiment described here, the execution module 5 is configured for choosing, in response to the suspicious behavior of the address bad@IP, at least one of the actions ACT2 or ACT3, then for executing the action or the actions thus chosen (step E50). It may furthermore, as a complement to the action ACT2 and/or ACT3, also execute the action ACT1. Of course, the invention is not limited to the aforementioned actions and other actions may be envisioned and executed as a variant by the operator NAT CGN #1 such as, for example, updating a set of the reputation system REP_SYS, marking the packets using the address bad@IP in order to facilitate the recognition and the classification of the traffic so that traffic sinks may be dynamically set up within the network 2, etc.

Furthermore, it should be noted that the action or actions selected by the execution module 5 may be executed by the latter for a limited period of time. For example, the execution module 5 may, in accordance with the action ACT1, remove the address bad@IP from the list of the IP addresses able to be selected for processing the messages of the client equipments that it serves during a given period of time, here denoted by PAUSE_TIMER. If, at the end of the period PAUSE_TIMER, the detection module 4 no longer detects any suspicious behavior associated with the address bad@IP (for example, it does not receive any new notification from a DMS system or from a REP_SYS system relating to this IP address), in this case it may re-activate the address bad@IP, in other words reintegrate it amongst the IP addresses of the set POOL #1 able to be selected for processing messages arriving at CGN #1.

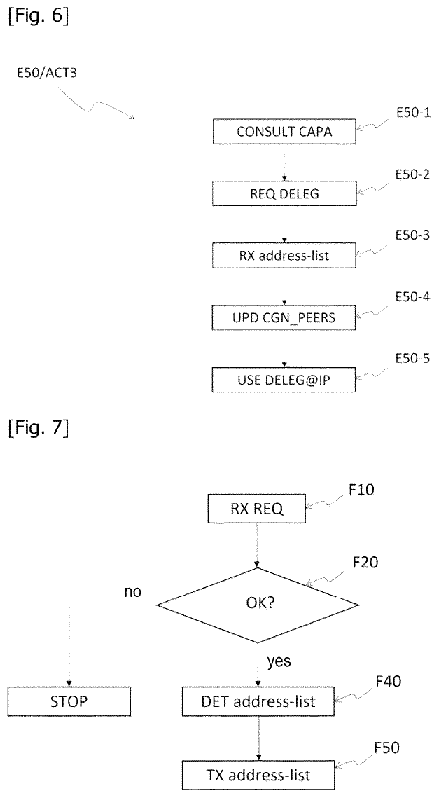

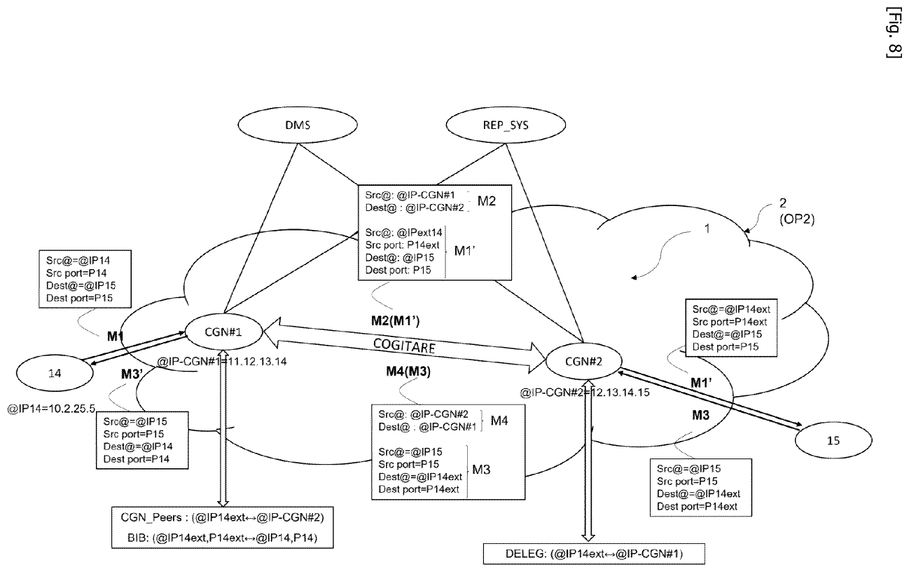

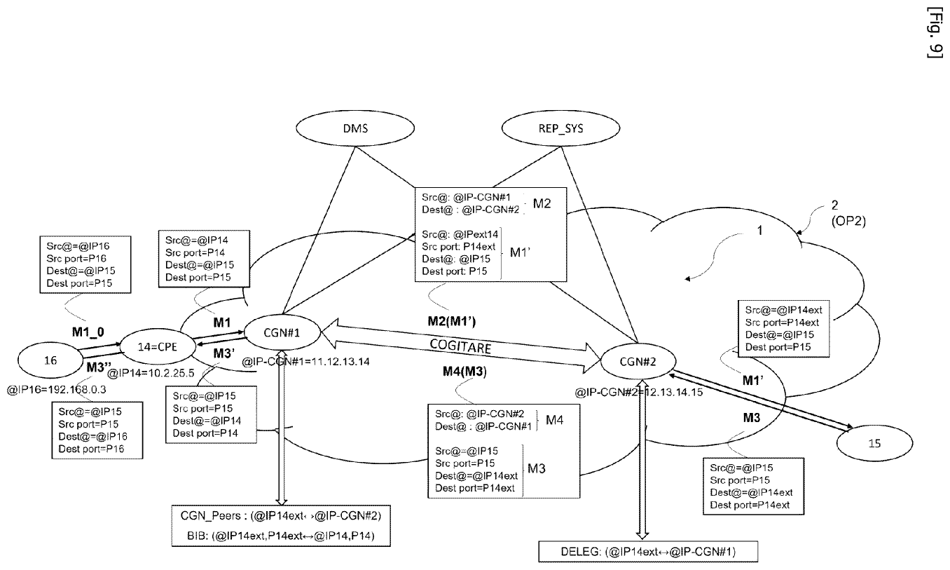

The sequence of operations of the step E50 when the action ACT3 (request for delegation of IP addresses to another operator NAT) is selected by the execution module 5 will now be described in more detail with reference to FIGS. 6 and 7. FIG. 6 illustrates the steps implemented by the operator NAT CGN #1 responsible for the delegation request, whereas FIG. 7 illustrates the steps implemented by an operator NAT of the system 1 receiving and accepting this delegation request (in other words acting as a second device in the sense of the invention). The steps illustrated in FIG. 7 correspond to those of a collaboration method according to the invention. It goes without saying that, although being described on the basis of one illustrative example, the steps shown in FIGS. 5 to 7 are applicable to all the operator NATs of the system 1 according to the role played by each of them (first or second device according to the invention).

In the embodiment envisioned here, as previously described, COGITARE channels have been established, in an initial step E20, by CGN #1 with the operator NATs of the system 1 discovered during the step E10. Furthermore, during the establishment of these COGITARE channels, CGN #1 has been informed by the operator NATs, with which it has established these channels, of their aptitude or otherwise to delegate IP addresses to other operator NATs of the system 1. This information is stored in the table CAPA of CGN #1. Thus, following the selection of the action ACT3, the execution module 5 of CGN #1 consults the table CAPA and determines to which operator NAT(s) of the system 1 it can address its request to delegate IP addresses (these are operator NATs capable of implementing the invention and hence able to delegate IP addresses, in other words in the example envisioned here, those having indicated a parameter “delegate_resources_enable” with a value 1) (step E50-1).

It should be noted that, as a variant, the discovery step E10 and the step E20 for establishing the COGITARE channels may be implemented by the operator NAT CGN #1 after the step E30 for detecting suspicious behavior associated with the address bad@IP, for example after the execution module 5 has decided to execute the action ACT3.

The execution module 5 of CGN #1 requests from at least one of the operator NATs identified during the step E50-1 to delegate at least one IP address to it from amongst the set POOL of IP addresses that it is managing (step E50-2). It should be noted that the execution module 5 may address this delegation request to all the operator NATs identified during the step E50-1 or to only a part of them (it may for example choose one of them randomly, or according to a given criterion, etc.). For the sake of simplicity, it is assumed that CGN #1 addresses its delegation request to a single operator NAT of the system 1, namely to the operator NAT CGN #2 (second device in the sense of the invention).

In the embodiment envisioned here of COGITARE channels relying on the QUIC protocol, the execution module 5 of CGN #1 requests a delegation of IP addresses to CGN #2 by sending it a QUIC frame, specified for the needs of the invention and here called for example IP_RESOURCE_DELEGATE. This frame is sent by CGN #1 to CGN #2 via the COGITARE channel established between them. It may be empty (and hence does not contain any parameter) or, as a variant, contain one or more parameters specifying the request from CGN #1, such as for example a parameter here called “requested-size” indicating a preference relating to the size of the space of the IP addresses to be delegate or, in an equivalent manner, a parameter here called “requested-nb” indicating a number of desired delegated addresses, a parameter here called “requested-af” indicating the type of desired delegated IP addresses (for example with a value of 0 for IPV4 addresses and of 1 for IPV6 addresses, where the absence of this parameter may be considered as equivalent to a value of the parameter set at 0, in other words such as denoting IPv4 addresses), etc.

Thus, by way of illustration, a frame IP_RESOURCE_DELEGATE comprising a parameter “requested-size” with a value of 32 (bits) and not containing a parameter “requested-af” indicates a request for delegation of a single IPV4 address (the parameter “requested-size” combined with the absence of a parameter “requested-af” indeed indicates a number of desired delegated IP addresses). Of course, other parameters may be included in the delegation request IP_RESOURCE_DELEGATE, such as for example, a desired delegation duration, etc.

With reference to FIG. 7, the frame IP_RESOURCE_DELEGATE is received by CGN #2, by its receiver module 9, via the COGITARE channel established with CGN #1 (step F10).

If CGN #2 accepts the delegation request from CGN #1 (response yes to the test step F20), it establishes a list “address-list” of IP addresses comprising at least one available IP address, selected within the set POOL #2 that CGN #2 is managing and that it is ready to delegate to CGN #1 (step F40). It should be noted that the IP addresses delegated to CGN #1 are intended to be used by the latter for processing messages of client equipments which are attached to it; they must not therefore be used for processing messages exchanged in the framework of active connections of client equipments served by CGN #2, nor for futures connections. Aside from the absence of traffic associated with the IP addresses from the list “address-list”, CGN #2 may envision other criteria for selecting the addresses from the set POOL #2 that it accepts to delegate to CGN #1: it may for example select them randomly from amongst the unused addresses (in other words which are not active) from the set POOL #2, or select those which do not belong to a “block-list”, etc. In order to establish the list “address-list”, CGN #2 may furthermore take into account the preferences of CGN #1 potentially indicated in its delegation request (cf. parameters “requested-size”, “requested-nb”, “requested-af”, etc.). As a variant, when CGN #2 establishes the list “address-list”, it may be configured to ignore the preferences indicated by CGN #1.

In the embodiment described here, as further detailed later on, after having delegated an IP address from the set POOL #2 to CGN #1, CGN #2 continues to be involved in the management of the traffic destined for or sent out using this IP address. More particularly, it is configured for encapsulating, via its transmission/receiver module 11, in the COGITARE channel established with CGN #1, all the packets that it receives destined for this delegated IP address in order to transmit them to CGN #1 and, conversely, dis-encapsulating the packets using this delegated IP address that it receives via the COGITARE channel established with CGN #1 in order to transmit them to their respective destinations. During these operations, CGN #2 is configured so as not to carry out a translation of the delegated IP address (in contrast to what is done with the IP addresses of the set POOL #2 whose use is reserved for it, in other words which are not delegated to any other operator NAT). This embodiment advantageously allows updating of the tables for routing within the network 2 to be avoided, since CGN #2 continues to manage the traffic associated with the IP addresses that it delegates to other operator NATs of the system 1.

Once the list “address-list” has been established, CGN #2 saves in a table here named DELEG, stored for example in its non-volatile memory NVM, the IP addresses of the list “address-list” delegated to CGN #1 in association with an identifier of CGN #1, for example its IP address@IP-CGN #1.

CGN #2 subsequently sends, by means of its transmission module 10 and via the COGITARE channel established with CGN #1, a favorable response to the delegation request from CGN #1 including the list “address-list” thus established (step F50). In the embodiment described here of a COGITARE channel relying on the QUIC protocol, the response from CGN #2 is a frame IP_RESOURCE_DELEGATE including the list “address-list”. This response may furthermore include other information, such as for example a parameter here named “validity” indicating the time during which the IP addresses of the list “address-list” is delegated to CGN #1, a parameter here named “rate-limit” representative of the maximum volume of traffic associated with the use of a delegated IP address from the list “address-list” that CGN #2 can manage (in view of the fact that it remains involved in the management of this traffic as previously indicated), etc.

The response IP_RESOURCE_DELEGATE from CGN #2 is received by CGN #1 and transmitted to its execution module 5 (step E50-3). The execution module 5 then records in a table CGN_PEERS, stored for example in the non-volatile memory NVM, the delegation offer or offers received from the operator NAT(s) to which it has sent a delegation request at the step E50-2, in other words, in the illustrative example envisioned here CGN #2 (step E50-4). More particularly, in the embodiment described here, the execution module 5 of CGN #1 stores in the table CGN_PEERS, for each operator NAT having delegated IP addresses to it (in other words in the example envisioned, for CGN #2):
an identifier of the operator NAT (in other words in the example envisioned, an identifier of CGN #2);
the list of the addresses delegated by the operator NAT (in other words in the example envisioned, the list “address-list”);
the duration of validity of the delegation of addresses by the operator NAT (in other words in the example envisioned, the duration indicated by CGN #2 in the parameter “validity”); and
the maximum volume of traffic associated with the addresses delegated by the operator NAT able to be managed by the latter (in other words in the example envisioned, the volume indicated by CGN #2 in the parameter “rate-limit”).

Here, for the sake of simplicity, the same value of duration of validity and of maximum volume for the set of the IP addresses of the list “address-list” are assumed. However, this assumption is not limiting per se and different values may be envisioned depending on the delegated IP addresses.

Accordingly, CGN #1 is able to use the delegated IP addresses listed in the table CGN_PEERS, in addition to the IP addresses of the set POOL #1 (except for those potentially removed during the execution of the action ACT1), for processing the packets that it receives from the client equipments (step E50-5). Thus, by virtue of the invention, the set POOL #1 is de facto extended from which the CGN #1 benefits for processing the packets arriving at it.

If the IP addresses delegated to CGN #1 are associated with a limited duration of validity, then CGN #1 is locally configured to use these delegated IP addresses only for a period of time less than or equal to this duration of validity. If CGN #1 needs to use a delegated IP address beyond of the duration of validity specified by CGN #2, then CGN #1 may be configured to ask CGN #2 for an extension of this duration of validity or to request from another operator NAT of the system 1 the delegation of other IP addresses and to release, as the case may be, the delegated IP address or addresses whose duration of validity has expired to CGN #2. It should be noted that CGN #1 may release an IP address delegated by CGN #2 prior to the expiration of its duration of validity, for example by sending a QUIC frame to CGN #2 introduced for the needs of the invention called for example RELEASE_RESOURCES and including the delegated IP address in question.

If no duration of validity is specified, the use by CGN #1 of a delegated IP address may be limited to a period of time defined by default (for example 24 hours), or for as long as CGN #1 needs the delegated IP address in question (for example for as long as the detection module 4 associates a dishonest behavior with the address bad@IP), or else for as long as CGN #1 is not notified to cease this use (for example by CGN #2 or by the operator OP2 of the network 2), etc.

Furthermore, as mentioned previously, in the embodiment described here, the traffic associated with an IP address delegated to CGN #1 by CGN #2 continues to transit via CGN #2 through the COGITARE channel established between the two operator NATs. This results in CGN #1 being configured for sending to CGN #2, via its transmission/receiver module 8, all the packets that it processes and for which it has selected an IP address delegated by CGN #2.

Furthermore, if a maximum volume of traffic able to be managed by CGN #2 has been indicated to CGN #1 (typically via the parameter “rate-limit”), CGN #1 is preferably configured for complying with this maximum volume, for example it may be configured for distributing the traffic associated with separate client equipments over several COGITARE channels, and hence for selecting, for these individual client equipments, IP addresses delegated by separate operator NATs of the system 1. CGN #2 may furthermore be configured to chop off the traffic associated with the IP addresses delegated to CGN #1 beyond the indicated maximum volume, if CGN #1 does not comply with this maximum volume.

FIG. 8 illustrates by one example what has just been described and, more particularly, how CGN #1 and CGN #2 process the packets associated with an IP address delegated by CGN #2 to CGN #1. For the sake of simplicity, only the operator NATs CGN #1 and CGN #2 of the system 1 are shown in FIG. 8.

With this figure, it is assumed that, after execution of the action ACT3, CGN #1 receives a packet M1 from a client equipment 14 to which an internal IPV4 address denoted @IP14 and a port number P14 are allocated, for example @IP14=10.2.25.5 and P14=12345. The packet M1 transports data sent out by the client equipment 14 and destined for a destination entity, for example here a server 15 identified by a destination IPv4 address denoted @IP15 and a destination port number denoted P15; for example @IP15=1.2.3.4, P15=9856.

The packet M1 sent out by the client equipment 14 is received by CGN #1; it is therefore received by CGN #1 and the header of the packet contains the internal source IP address and port number @IP14 and P14.

Upon receipt of the packet M1, CGN #1 consults, via its management module 12, the BIB table stored in its non-volatile memory NVM and determines whether an entry corresponding to the pair (@IP14,P14) already exists in the table.

If no corresponding entry exists in the BIB table, the management module 12 selects an external IP address and, in the example envisioned here, an external port number, respectively denoted @IP14ext and P14ext, for processing the packet M1 coming from the client equipment 14 (it should however be noted that the port number P14 is not necessarily modified by the management module 12). The IP address @IP14ext here is selected from amongst the IP addresses delegated by CGN #2 listed in the table CGN_PEERS. A new entry is then created by the management module 12 in the BIB table associating the pair (@IP14, P14) with the pair (@IP14ext, P14ext). For the sake of simplicity here, it is assumed that, in the BIB table, the address @IP14ext is only associated with the internal IP address @IP14.

If an entry which corresponds to this packet exists in the BIB table, the management module 12 extracts the external IP address and the port number (@IP14ext, P14ext) corresponding to this entry in the BIB table.

In the following, by way of illustration, it is considered that @IP14ext=25.25.65.2 and P14ext=4859. CGN #1 subsequently translates the internal IP address@IP14 and port number P14 of the packet M1 into the external IP address@IP14ext and port number P14ext (in other words, in the header of the packet, it replaces @IP14 and P14 by @IP14ext and P14ext, respectively), resulting in a modified packet M1′. It should be noted that, as previously mentioned, other modifications may be applied by CGN #1 to the packet M1. Here however, for the sake of simplicity, such modifications are not further described here.

Then, in the embodiment described here, it encapsulates the packet M1′ in a packet QUIC M2 (also commonly denoted by QUIC frame M2) having as source IP address the external IP address @IP-CGN #1 of CGN #1, for example @IP-CGN #1=11.12.13.14. The port number used, denoted P1, may be a port number chosen randomly during the establishment of the COGITARE channel with CGN #2, as described for example in the document RFC 6056 entitled “Recommendations for Transport-Protocol Port Randomization”, January 2011. It should be noted that, in the example envisioned here of a QUIC communication channel established between CGN #1 and CGN #2, it is the identifier CID of the connection established between the two operator NATs which is used by the latter, and the port number used does not matter.

As the external IP address @IP14ext selected by CGN #1 for processing the packet M1 is an IP address delegated by CGN #2, CGN #1 transmits the frame M2 by means of its transmission/receiver module 8 to CGN #2 via the COGITARE channel established between the two operator NATs, so that the data transported by the packet M1′ (or in an equivalent manner by the packet M1) are routed by CGN #2 to their destination, in other words to the server S. The frame M2 therefore has in its header, as destination IP address, the external IP address @IP-CGN #2 of the CGN #2.

Upon receipt of the frame M2, CGN #2 verifies, by means of its table DELEG, whether the source IP address (in other words here the address @IP-CGN #1) corresponds to an IP address of its set POOL #2 delegated to CGN #1, the frame M2 being received via the COGITARE channel established with CGN #1.

If this is not the case (for example, no entry in the table DELEG corresponding to the source IP address @IP-CGN #1 of the frame M2), CGN #2 eliminates the frame M2.

If this is the case, CGN #2 de-encapsulates the packet M1′ from the frame M2 then transmits the packet M1′ to its destination, in other words to the server S, without carrying out any translation of addresses on the packet M1′. The packet M1′ transmitted to the server S therefore has, in its header:
as source IP address and port number: the external IP address @IP14ext=25.25.65.2 delegated by CGN #2 to CGN #1 and the external port number P14ext=4859; and
as destination IP address and port number: the IP address@IP15=1.2.3.4 and the port number @P15=9856.

It is assumed that the server S responds to the client equipment 14 by sending it a packet M3 containing data. The packet M3 is sent out by the server S with the source IP address @IP15=1.2.3.4 and the source port number @P15=9856. The data are destined for the client equipment 14 and hence for the external IP address @IP14ext=25.25.65.2 delegated by CGN #2 to CGN #1 and for the external port number P14ext=4859.

Since the packet M3 is intended for an IP address of the set POOL #2 managed by the CGN #2, in the embodiment described here, it is sent to CGN #2.

Upon receiving the packet M3, CGN #2 verifies whether the destination IP address of the packet M3 is an IP address of the set POOL #2 of IP addresses that it is managing and delegated to another operator NAT of the system 1. For this purpose, it uses its table DELEG.

If it does not find any corresponding entry for @IP14ext in the table DELEG, but it is indeed an IP address belonging to the set POOL #2, CGN #2 processes the packet M3 according to a conventional procedure NAT44, and it translates the external IP address @IP14ext and the external port number P14ext into an internal IP address and an internal port number if an entry is locally active in its BIB table.

If an entry in the table DELEG is found by CGN #2 then, in the embodiment described here, it encapsulates the packet M3 into a QUIC frame M4 (packet in the sense of the invention) without modifying the destination IP address (in other words the address @IP14ext) of the packet M3 encapsulated in the frame M4, and hence incidentally without modifying the data that the packet M3 contains. It subsequently transmits the frame M4 to CGN #1 by means of its transmission/receiver module 11, via the COGITARE channel established between the two operator NATs. The frame M4 contains the packet M3 (in particular the data sent out by the server S and destined for the client equipment 14) and has in its header, as source IP address, the IP address@IP-CGN #2 of the CGN #2 and, as destination IP address, the IP address@IP-CGN #1 of the CGN #1. Here, for the sake of simplicity, the port numbers used between CGN #1 and CGN #2 are omitted, for the reasons previously explained.

Upon receipt of the frame M4, CGN #1 verifies that the source IP address @IP-CGN #2 of the frame M4 corresponds to an entry in its table CGN_PEERS. If this is not the case, the frame M4 is eliminated.

If the source IP address @IP-CGN #2 of the frame M4 corresponds to an entry in the table CGN_PEERS, CGN #1 extracts the packet M3 from the frame M4. Then, it verifies in its BIB table whether an entry corresponding to the destination IP address of the packet M3 (in other words here to the external IP address @IP14ext) exists.

If no entry exists in the BIB table for this IP address, CGN #1 eliminates the packet M3.

If an entry exists (in other words this IP address has been previously selected by CGN #1 for processing the messages of a client equipment or an entry in the BIB table has been explicitly created using a dedicated interface), it replaces in the packet M3 the destination address @IP14ext and port number P14ext by the internal IP address and port number associated with them in the BIB table, in this case here by the internal IP address @IP14 and by the internal port number P14 of the client equipment 14.

Then, the packet M3 thus modified, denoted in the following by M3′, is transmitted to the client equipment 14 by CGN #1.

It should be noted that what has just been described for COGITARE channels relying on the QUIC protocol may be applied in an identical manner to COGITARE channels relying on another protocol, as long as the encapsulation of the packets M1′ and M3 is implemented in messages conforming to this other protocol. For example, for the IP-in-IP protocol, the packets M1′ and M3 should be encapsulated in IP packets instead of encapsulating them in QUIC frames.

In the example in FIG. 2, the client equipment of the network 2 are terminals communicating directly with the operator NATs of the system 1. As previously mentioned, it may be envisioned for the invention to be applied to other types of client equipment of the network 2 and notably to equipment for accessing the network 2 such as CPEs connecting, for example, terminals connected to a local area network (LAN) to the network 2. In this case, the invention is applied in an identical manner to what has been described for a client equipment of the terminal type for a CPE. However, as previously mentioned, there is an additional step, known per se, for translation of addresses within the CPE.

FIG. 9 illustrates this additional step. More precisely, the client equipment 14 in FIG. 9 is now a CPE (instead of a terminal such as indicated in FIG. 8), used as equipment for accessing the network 2 by a terminal 16 connected to a LAN. The invention is applied by the CGN #1 and CGN #2 in an identical manner to what has been described with reference to FIG. 8 for the terminal 14. In FIG. 9, the packet M1 results however from a modification by the CPE 14 of a packet M1_0 generated by the terminal 16 containing data destined for the server S, this packet M1_0 having as source IP address and port number an internal IP address and port number denoted @IP16 and P16, respectively, allocated by the CPE 14 to the terminal 16. The modification carried out by the CPE 14 on the packet M1_0, resulting in the packet M1, consists in replacing, in the header of the packet M1_0, the internal IP address@IP16 and port number P16 by the IP address@IP14 and the port number P14 allocated to the CPE 14. The inverse modification is applied by the CPE 14 to the packet M3′ resulting in a packet M3″ then sent to the terminal 16.

Everything that has just been described with reference to FIGS. 2 to 9 for the operator NATs CGN #1 and CGN #2 may be applied in a similar or identical manner to the other operator NATs of the system 1. Furthermore, the operator NAT CGN #1 may obtain IP addresses delegated by several operator NATs of the system 1. What has just been described for CGN #2 is then applicable in a similar or identical manner to the various operator NATs delegating IP addresses to CGN #1.

In the embodiment described with reference to FIGS. 2 to 9, the system 1 is configured such that, when an operator NAT CGN #j of the system 1 delegates one or more IP addresses to an operator NAT CGN #k, with kj, CGN #j continues to receive the traffic associated with these delegated IP addresses. In other words, the routing tables held by the routers of the network 2 are not modified, which allows CGN #k to immediately use the IP addresses which have been delegated to it, in a manner that is transparent for the client equipment that it serves. In another embodiment, following the delegation of IP addresses by CGN #j to CGN #k, it may be envisaged for the routing tables to be modified in such a manner that the traffic associated with these delegated IP addresses (incoming and outgoing) is routed directly to CGN #j (without transiting via the COGITARE channel established between CGN #j and CGN #k), for the delegation time.

In the embodiment described with reference to FIGS. 2 to 9, the assumption has been made that a single level of operator NAT is deployed within the network. The invention is however also applicable in a context where several levels of operator NATs are deployed within the network 2 (leading to several successive translations of addresses applied to the messages transiting via the network). In such a context, the delegation of IP addresses is implemented according to the invention, in an identical manner to what has just been described, between operator NATs belonging to the same level.

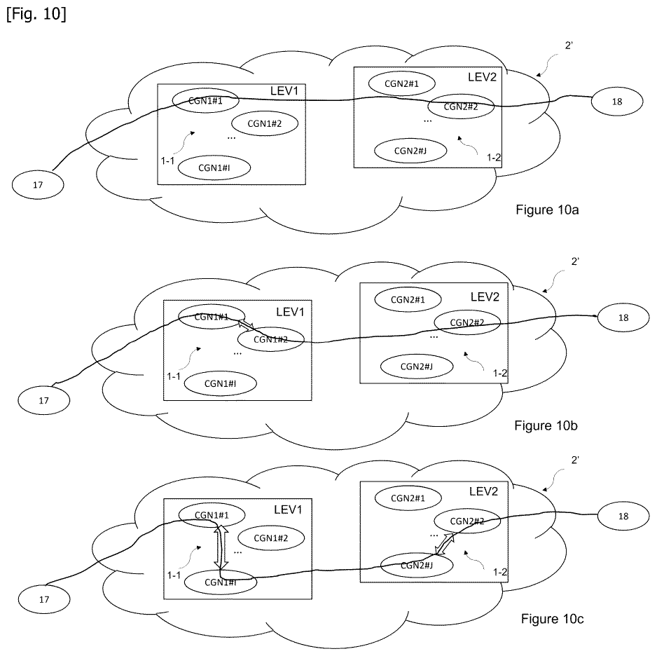

FIG. 10 illustrates one example of a network 2′ comprising two levels of operator NATs LEV1 and LEV2, the level LEV1 comprising I operator NATs CGN1 #m, m=1, . . . ,I, forming a system 1-1 according to the invention and the level LEV2 comprising J operator NATs CGN2 #k, k=1, . . . ,J, forming a system 1-2 according to the invention, I and J denoting integers greater than 1. In each level LEVi, i=1,2, each operator NAT of the system 1-i comprises the functional modules 4 to 13 previously described and is capable of acting, depending on the context, as a first device or a second device according to the invention. The management and collaboration methods according to the invention which have just been described with reference to the operator NATs CGN #n, n=1, . . . ,M in FIGS. 2 to 9 are therefore applicable in a similar or identical manner within each level LEVi and, more particularly, each system 1-i according to the invention, i=1,2 between the operator NATs of this system. In other words, each operator NAT CGNi #p of the system 1-i deployed at the level LEVi is able to request a delegation of IP addresses or to delegate one or more IP addresses to one or more operator NATs CGNi #t, with t+p, belonging to the same system 1-i and hence at the same level LEVi as it. COGITARE channels (represented by double arrows in FIG. 10) may thus be established between operator NATs of the same level.

FIG. 10 illustrates various situations experienced by the systems 1-1 and 1-2 in the network 2′.

More precisely, FIG. 10a illustrates the state of the network 2′ and of the systems 1-1 and 1-2 in a normal state (nominal conditions). Each operator NAT within a system 1-i, i=1,2 manages a set of separate IP addresses and uses the addresses that it is managing for processing the packets of the client equipments that it serves (CPEs or terminals in the example in FIG. 10). Each packet of a client equipment (sent out from or destined for the latter) successively transits within the network 2′ via two operator NATs respectively belonging to the level LEV1 and to the level LEV2. For processing this packet, each operator NAT selects an IP address from within the space POOL of IP addresses which has been assigned to it. Thus, by way of illustration in FIG. 10a, a message associated with a terminal 17 transits via the operator NAT CGN1 #1 in the system 1-1 and via the operator NAT CGN2 #2 in the system 1-2.

FIG. 10b illustrates a situation in which the detection module 4 of a CGN1 #m of the system 1-1, for example CGN1 #1, detects a malicious behavior associated with an address that it is managing and sends, via its execution module 5, in response to this malicious behavior, a request for delegation of at least one IP address to another operator NAT of the system 1-1, for example to CGN1 #2. In the example in FIG. 10b, following the delegation of at least one IP address by CGN1 #2 to CGN1 #1, CGN1 #1 selects one of the IP addresses delegated by CGN1 #2 for processing the packets associated with the terminal 17. These messages, when they contain data sent out by the terminal 17 and destined for a server 18, transit via CGN1 #1 which replaces their internal IP address by an IP address delegated by CGN1 #2 (or vice versa), then sends it via the COGITARE channel to CGN1 #2 for it to be sent to the server 18. In accordance with the routing rules established within the network 2, the packets are transmitted by CGN1 #2 to an operator NAT of the system 1-2 deployed at the level LEV2 (CGN1 #2 not then carrying out any translation of addresses for the packets in question), for example to CGN2 #2, responsible for applying to the packets received from CGN1 #2 a new step for translation of addresses before they are routed to server 18. The packets sent out by the server 18 containing data destined for the terminal 17 follow the reverse path: they transit via CGN2 #2 which performs a translation of addresses, then are sent by CGN2 #2 to CGN1 #2 which in turn transmits them, within the COGITARE channel, to CGN1 #1 without carrying out a translation of addresses. After having replaced the delegated external IP address used for the packets by an internal IP address allocated to the terminal 17, CGN1 #1 sends these packets to the terminal 17.

FIG. 10c illustrates a situation in which, within each system 1-i deployed at each level LEVi, a malicious behavior associated with an IP address managed by an operator NAT of the system 1-i is detected, triggering a request for delegation of IP addresses and a delegation of IP addresses at each level. In the example illustrated in FIG. 10c, a malicious behavior associated with an IP address managed by the operator NAT CGN1 #I of the system 1-1 and a malicious behavior associated with an IP address managed by the operator NAT CGN2 #2 of the system 1-2 are detected, resulting in a delegation of IP addresses by CGN1 #1 to CGN1 #I and in a delegation of IP addresses by CGN2 #J to CGN2 #2.

It goes without saying that the invention is not limited to two levels of operator NATs deployed within the network and that a higher number of levels of NAT may be envisioned, the invention being applicable in the same way as what has previously been described with reference to FIGS. 2 to 9, independently at each level.

Finally, the invention has been described with reference to operator NATs. However, the invention may be applied to other devices managing a plurality of IP addresses able to be shared between several client equipments, such as for example to devices implementing a proxy function using their own IP addresses for relaying messages received. Such devices are for example described in the sections 5, 6 and 7 of the aforementioned document RFC 7620. The invention is also applicable when the IP addresses managed by the first and/or second devices are not shared between several client equipments.

1. A management method for managing, by a first device located in a network, a first set of IP addresses, said method comprising:
detecting suspicious behavior associated with an IP address of said first set selected by the first device for processing at least one data packet of a client equipment served by the first device;
executing, following said detection, at least one action from between:
an adjustment of at least one sharing ratio of at least one IP address of the first set applied by the first device;
a request, addressed to at least a second device managing a second set of IP addresses, for delegation of at least one IP address of the second set to the first device in order for the first device to be able to select said at least one delegated IP address for processing at least one data packet of at least one client equipment served by the first device.

2. The management method as claimed in claim 1, in which the detecting comprises receipt of a notification from an attack detection function or from a system for reputation of IP addresses.

3. The management method as claimed in claim 1, furthermore comprising discovering said at least a second device.

4. The management method as claimed in claim 1, furthermore comprising establishing at least one communication channel with said at least a second device.

5. The management method as claimed in claim 4, in which said at least one communication channel is an encrypted communication channel relying on the Quick User Data Protocol (UDP) Internet Connections (QUIC) protocol.

6. The management method as claimed in claim 1, in which said delegation request comprises a desired number and/or type of delegated Internet Protocol (IP) addresses.

7. The management method as claimed in claim 1, furthermore comprising receiving, in response to said delegation request addressed by the first device to said second device, at least one element from amongst:
a list comprising at least one IP address delegated by this second device to the first device;
a time during which said list is delegated to the first device;
information representative of a maximum volume of traffic associated with the use of an IP address delegated by said second device to the first device able to be managed by the second device.

8. The management method as claimed in claim 1, furthermore comprising:
receiving, from an internal source IP address, a first data packet comprising data destined for a destination entity;
replacing said internal source IP address with said IP address delegated by said second device to the first device and selected by the first device for processing said first data packet; and
transmitting said data with said IP address delegated to said second device, via a communication channel established with the second device, so that said data are routed to the destination entity.

9. The management method as claimed in claim 1, furthermore comprising:
receiving, via a communication channel established with said second device, a second data packet sent out by a transmitting entity and comprising data destined for an IP address of the second set of IP addresses managed by the second device;
if said IP address is delegated to the first device by the second device and selected by the first device for processing data packets of a client equipment served by the first device, transmitting said data to an internal IP address allocated to said client equipment.

10. The management method as claimed in claim 1, comprising selecting at least two IP addresses delegated by said separate second devices for processing the data packets of at least two separate client equipments.

11. The management method as claimed in claim 3, in which the discovering is implemented before the detecting.

12. A collaboration method for collaborating with a first device located in a network and managing a first set of IP addresses comprising an IP address associated with suspicious behavior, said method being implemented by a second device managing a second set of IP addresses and comprising:
receiving a request, coming from the first device, to delegate at least one IP address of the second set to the first device in order for the first device to be able to select said at least one delegated IP address for processing at least one data packet of at least one client equipment served by the first device; and
sending to the first device a list comprising at least one IP address of the second set delegated by said second device to the first device.

13. The collaboration method as claimed in claim 12, furthermore comprising:
receiving, via a communication channel established with the first device, a first data packet comprising data destined for a destination entity and sent out with a source IP address belonging to the second set of IP addresses managed by the second device;
if said source IP address is a said IP address delegated by the second device to the first device, transmitting said data to the destination entity without modifying said source IP address of said data.

14. The collaboration method as claimed in claim 12, furthermore comprising:
receiving a second data packet comprising data sent out by a transmitting entity and destined for a destination IP address belonging to the second set of IP addresses managed by the second device;
if said IP address is said IP address delegated by the second device to the first device, transmitting said data to the first device via a communication channel established with said first device without modifying said destination IP address of said data.

15. A non-transitory computer readable medium comprising a computer program stored thereon comprising instructions for implementing the management method as claimed in claim 1 when said program is executed by a computer of said first device.

16. A first device locatable in a network, said first device configured to manage a first set of IP addresses and comprising:
at least one processor; and
at least one non-transitory computer readable medium comprising instructions stored thereon which when executed by the at least one processor configure the first device to:
detect suspicious behavior associated with an IP address of said first set selected by the first device for processing at least one data packet from a client equipment served by the first device;
execute, following said detection, at least one action from between:
an adjustment of at least one sharing ratio of at least one IP address of the first set applied by the first device;
a request, addressed to at least a second device managing a second set of IP addresses, to delegate at least one IP address of the second set to the first device in order for the first device to be able to select said at least one delegated IP address for processing at least one data packet of at least one client equipment served by the first device.

17. A second device locatable in a network, said second device configured to manage a second set of IP addresses and comprising:
at least one processor; and
at least one non-transitory computer readable medium comprising instructions stored thereon which when executed by the at least one processor configure the second device to:
receive a request, coming from a first device managing a first set of IP addresses comprising an IP address associated with suspicious behavior, to delegate at least one IP address of the second set to the first device in order for the first device to be able to select said at least one delegated IP address for processing at least one data packet of at least one client equipment served by the first device; and
send to the first device a list comprising at least one IP address of the second set delegated by said second device to the first device.

18. (canceled)

19. The management method as claimed in claim 4, in which the establishing said communication channel is implemented before the detecting.

20. A non-transitory computer readable medium comprising a computer program stored thereon comprising instructions for implementing the management method as claimed in claim 12 when said program is executed by a computer of said second device.
